(19) United States
(12) Patent Application Publication
(10) Pub. No.: US 2005/0213445 A1
(43) Pub. Date: Sep. 29, 2005

(54) Device for processing demonstration signals and demonstration control data

(75) Inventor: Daniel Graf, Vienna (AT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/518,252

(22) PCT Filed: May 26, 2003
(86) PCT No.: PCT/IB03/02302

§ 371 Date: Dec. 16, 2004

(30) Foreign Application Priority Data
Jun. 25, 2002 (EP) 02100745.5

(51) Int. Cl. G11B 5/09

(52) U.S. Cl. 369/47.1

(57) ABSTRACT

At a playback device (10) comprising at least one signal processing means for processing a signal and switching means for switching the playback device (10) into a demonstration mode a demonstration of an inherent function of the playback device (10) can be performed. Therein supply means (40) for supplying demonstration data for the demonstration and data reading means (40) for reading demonstration control data of a data carrier (41) which comprises demonstration control data for performing the demonstration are embodied as well as processing means (53) for processing the demonstration control data such that the demonstration data are transmittable to the at least one signal processing means during processing of the demonstration control data.

The invention relates to a data carrier comprising demonstration data.

The invention also relates to a playback device for performing a demonstration.

Such a data carrier and such a playback device are known in the form of an audio device of the MC-70 type marketed by applicant. The audio device supports, among other things, a so called “woox” technology. The “woox” technology ensures superior bass results in that dual-suspension bass radiators in conjunction with a dedicated amplifier circuitry are especially designed to produce and handle high dynamic sound signals at very low frequencies. Advantageously, the “woox” function is demonstrated to a prospective buyer of such an audio device. In the case of the type of the audio device mentioned, there is a special demonstration mode stored in a non-volatile memory of the audio device, which demonstration mode can be activated by means of a combined button or key input on the audio device. In order to implement the demonstration mode, a data carrier in the form of a familiar digital audio compact disc CD-DA comprising a demonstration signal is to be supplied from supply means, in this case a CD player of the audio device. The demonstration signal consists of a music track comprising an audio signal at a dedicated frequency range in order to support the “woox” technology described. In demonstrating the “woox” functionality, the audio signal will thus be reproduced through loudspeakers comprising the “woox” technology as an inherent function. In addition, an accompanying presentation on a display of the audio device will be performed. A major disadvantage of the described playback device is its limited possibility of carrying out enhanced or extended demonstrations or demos.

It is an object of the invention to eliminate the above drawback and to provide an improved data carrier and an improved playback system.

To achieve the object mentioned above, a data carrier as described in the opening paragraph has the characterizing features as defined in Claim 1.

To achieve the object mentioned above, a playback device of the type described in the second paragraph has the characterizing features as defined in Claim 7.

The features in accordance with the invention will lead to an improved data carrier and an improved playback device for performing a demonstration of an inherent function of the playback device. A major improvement consists in the fact that a very high flexibility in adding, removing, and editing or changing a demonstration or demonstration sequence of an inherent function of the playback device is obtained. The flexibility also includes the possibility of performing demonstrations in different languages for different regions in a simple manner. A further improvement lies in the fact that a demonstration can be performed for a plurality of modules or signal processing means of the playback device with a playback device comprising an internet audio module capable of accessing multiple digital music services via a broadband internet connection. For example, a demonstration of a function of an internet audio module may be given if there is no broadband internet connection available (for example in a store). The object of the demonstration is to provide information about the functions of a product and to demonstrate features of the product.

It was found to be advantageous in the embodiments of the invention if means as claimed in claim 3, claim 4, and claim 6 are provided. A simple handling is ensured thereby when a popular data carrier is used.

It was further found to be advantageous in the embodiments of the invention if means as claimed in claim 2 and claim 7 are provided. Only one data carrier is necessary then for performing the demonstration.

These and other aspects of the invention will be apparent from and elucidated with reference to the embodiments described hereinafter.

The invention will be better understood from the following description explaining the physical basis of the invention in conjunction with the enclosed drawings disclosing a preferred embodiment of the latter as a non-limitative example of implementation.

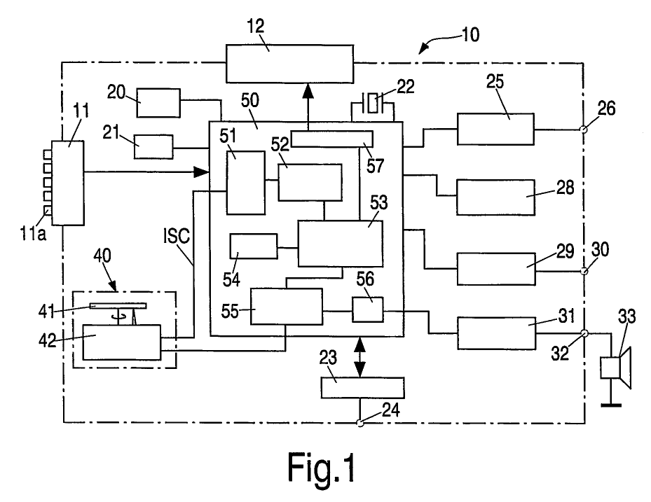

FIG. 1 is a block diagram showing an embodiment of the playback system according to the present invention.

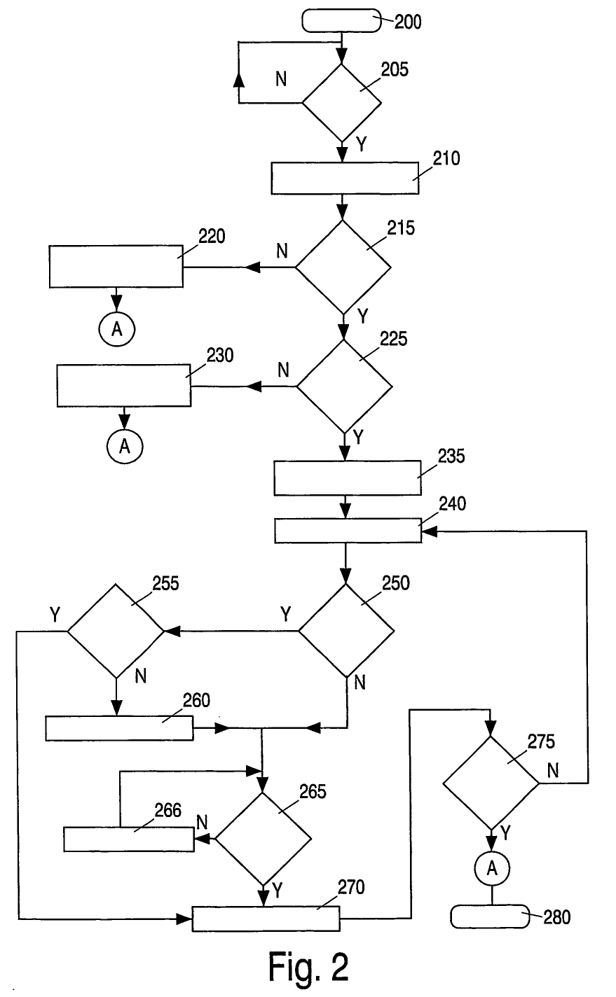

FIG. 2 is a flowchart showing a demonstration procedure carried out with a playback system according to the embodiment of the present invention.

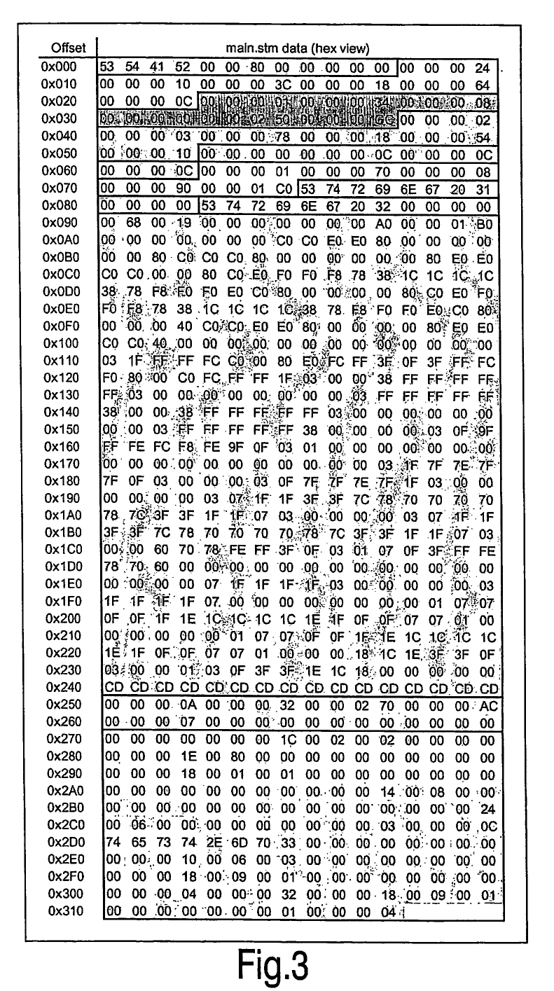

FIG. 3 is a hex view of a demonstration script file executed with a playback system according to the embodiment of the present invention.

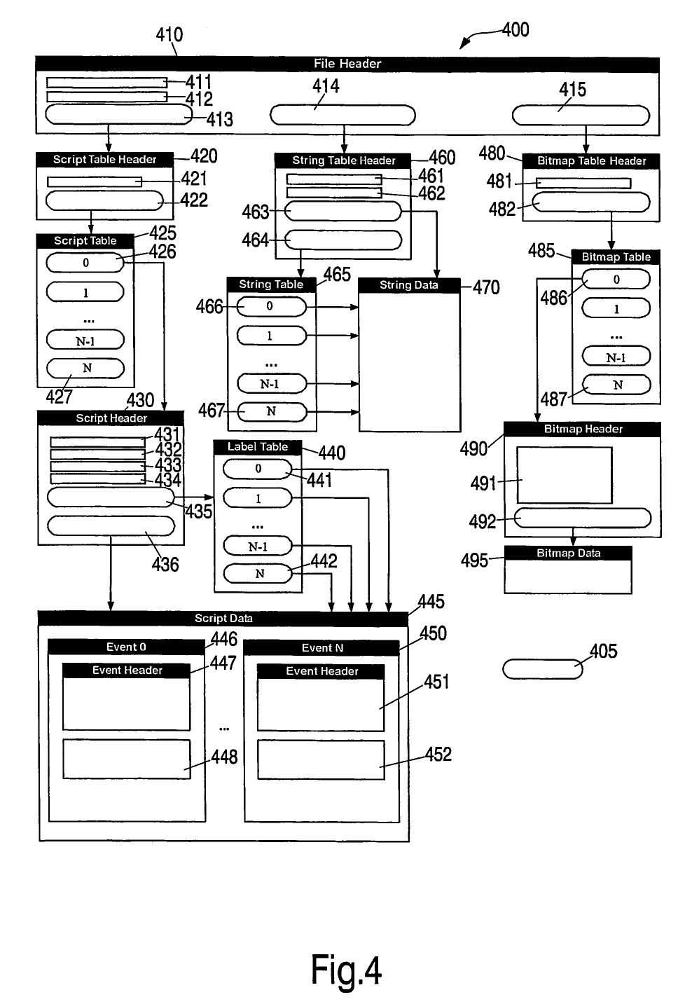

FIG. 4 shows a data structure of a script file used with a playback system according to an embodiment of the present invention.

It will be appreciated that the following description is intended to refer to specific embodiments of the invention selected for illustration in the drawings and is not intended to define or limit the invention, other than in the appended claims.

In order to best illustrate the utility of the present invention, it is described in conjunction with a playback system shown in FIG. 1, which playback system is constructed as a device and will be further referred to as playback device 10. The playback device 10 comprises input means 11 formed by a keyboard or buttons arranged at the playback device 10 such that they may be operated by a user of the playback device, and display means 12, in this case formed by an LCD dot-matrix display. It should be noted that alternative input means 11, for example a remote control, may be used, and instead of the LCD dot-matrix display, for example an LCD starburst display or a VFD display. The input means 11 and the display means 12 are connected to a CPU 50 which is provided for controlling the entire playback device 10. A temporary storage memory embodied by a random access memory RAM 21, a read-only memory ROM 20 for storing necessary program data, and oscillator means 22, a quartz crystal in this case, are connected to the CPU 50 for known purposes.

The playback device 10 further comprises signal processing means which are: a tuner module 25 with an antenna input connector 26, said tuner module 25 being constructed for receiving broadcast programs from different broadcasting stations, an internet audio module 28 for reproducing broadcast programs which are conveyed over a data network, an auxiliary module 29 with an auxiliary input 30, an amplifier module 31 comprising an amplifier output 32, and a data network interface 23 comprising a data network input 24. Reproduction means 33, here formed by a loudspeaker, are connected to the amplifier output 32. The signal processing means are connected to and controllable by the CPU 50.

The playback device 10 further comprises reading means for reading demonstration control data, which reading means in addition are constructed as supply means for the supply of demonstration data for a demonstration of an inherent function of the playback device 10, said reading means being a CD module 40 in this example. The CD module 40 consists of a loading unit (not shown) for loading a data carrier, i.e. a disc 41 in this case, onto a turntable, and a control unit 42 for controlling a reading head and servo of the CD module 40. The control unit 42 is connected to and controllable by the CPU 50 and is further constructed for reading data from the disc 41. In this example, the disc 41 stores data in accordance with the CD-ROM standard. It should be noted that a DVD module and corresponding standards such as DVD-R, DVD-RAM, DVD+RW, DVD-ROM, etc., may alternatively be used for the demonstration control data reading means and demonstration signal supply means.

The CPU 50 further comprises a CD driver unit 51 for driving and controlling the control unit 42 so as to obtain demonstration control data and demonstration signal data of the disc 41, which will be described in more detail below. Furthermore, demonstration control data recognition means 52 are provided, which means 52 are connected to the CD driver unit 51. Demonstration control data processing means 53 are connected to the demonstration control data recognition means 52, while a timer/counter 54, display driver means 57, and demonstration data signal processing means 55 are connected to the demonstration control data processing means 53.

FIG. 2 is a flowchart of the tasks performed by the CPU 50 with the ROM 20 and RAM 21 after the playback device 10 has been brought into a CD mode wherein a CD can be played in the CD module 40. The playback device 10 in this example may be brought into the CD mode through switching ON of the power of the playback device 10.

After starting at a box 200, in which the playback device 10 is brought into the CD mode and the CD module 40 is activated, the process will proceed with a decision operation 205 in which it is determined by the controller unit 42 and the CD driver unit 51 whether or not a disc 41 has been inserted into the CD module 40. If the disc 41 was inserted, a disc loading process is performed in operation 210 whereupon a spindle motor of the CD module 40 is driven into rotation. During the loading process, content data of the disc 41 such as a table of contents (TOC) will be read and buffered in the RAM 21. It is subsequently determined in a decision operation 215 in the CD driver unit 51 whether or not the inserted disc 41 complies with the CD-ROM specification. If it is not a CD-ROM, the process will proceed to an operation 220 where a further processing of the non-CD-ROM disc will be performed. The further processing of non-CD-ROM discs is not important in this context and will not be discussed here.

If the disc 41 is a CD-ROM, the process will proceed to a decision operation 225 in which the demonstration control data recognition means 52 test whether or not the inserted disc 41 contains a script file named “main.stm”. If there is no script file present named “main.stm”, the process will proceed to operation 230, where a normal treatment or playback of the disc 41 in accordance with the CD-ROM specification will be performed, otherwise the process will proceed to operation 235. In the operation 235, the playback device 10 is set for a demonstration mode in which information about capabilities and features of the playback device 10 and the included signal processing means are provided and demonstrated. Before proceeding with the flowchart shown in FIG. 2, the “main.stm” file will now be described in more detail.

The “main.stm” file, which is also referred to as a demonstration script file, contains demonstration control data in the form of a script which is a list of so-termed “events”. The events represent a controlled temporal succession or sequence of a demonstration of an inherent function of the playback device 10. Every event has a delta time, which is the time difference between a time of the previous event of a considered event in the sequence and a desired time of the considered event, at which desired time the considered event should be performed. The time difference or delta time should always be a positive value or zero (0). In the demonstration mode of the playback device 10, the script will be executed and the events will trigger certain actions in dependence on the delta times of the respective events.

In the present example, the “main.stm” file or demonstration script file contains not only the demonstration control data, but also demonstration data, which are strings and bitmap data to be displayed on the display means 12. A basic data structure of the “main.stm” file can be seen in FIG. 4. The data structure consists of demonstration control data and related header data of the demonstration control data, as well as parts of demonstration data and related header data of the parts of demonstration data in the form of bytes. The demonstration data in this example are used for providing additional information during a demonstration of an inherent function of the playback system 10, which additional information may include hints or indications on a use of an inherent function of the playback device 10.

A data structure 400 shown at FIG. 4 consists of: a file header 410 which comprises a file ID 411, a Cyclic Redundancy Check Value (CRC32) 412, a script table header location 413, a string table header location 414, and a bitmap table header location 415. Elements shown in FIG. 4 matching an illustration element 405 represent an address value and a size value, respectively, which means they are a location or a pointer to other data within the file.

The script table header location 413 points to a script table header 420 which contains a value number of scripts 421 and a script table location 422. The script table location 422 points to a script table 425 which contains N script pointers, which are a first script pointer 425 up to an N-th script pointer 427. Each of the script pointers in the script table 425 points to a script header. As is shown in FIG. 4, the script pointer 426 points to a script header 430. The script header 430 contains several values which are: ticks per second value 431, total ticks value 432, number of events value 433, number of labels value 434, a label table pointer 435, and a script location pointer 436. The script location pointer 436 points to a script data block 445 which contains N events: a first event 446 up to an N-th event 450. Each of the events 446 to 450 consists of an event header and extra data, i.e. event header 447 and extra data 448 of the first event 446 and event header 451 and extra data 452 of the N-th event 450. The label table pointer 435 points to a label table 440 which contains N label pointers, i.e. a first label pointer 441 up to an N-th label pointer 442 in this example. The label table 440 is optional and mainly helpful or advantageous in the case of larger scripts with a plurality of events. The label pointers thus provide exact addresses of so-called “key locations” in a script, which might be a first event at a logic unit or a demonstration sequence of a demonstration of an inherent function of the playback device 10.

As was noted above, parts of demonstration data may be provided within the script file, which in this example are strings and bitmaps as shown in FIG. 4. Similar to the script table, the string table header pointer points to a string table header 460 which contains a number of strings value 461, an encoding value 462, a string data pointer 463, and a string table pointer 464. The string table pointer points to a string table 465 which contains N string pointers: i.e. a first string pointer 466 up to an N-th string pointer 467. Each of the string pointers points to a string contained in a string data table 470. The bitmap table header pointer 415 points to a bitmap table header 482, the latter containing a number of bitmaps value 481 and a bitmap table pointer 482. The bitmap table pointer 482 points to a bitmap table 485 containing N bitmap pointers, i.e. a first bitmap pointer 486 up to an N-th bitmap pointer 487. Each of the bitmap pointers points to a bitmap header, for example, the bitmap pointer 486 points to bitmap header 490. The bitmap header 490 contains several bitmap data 491, for example, a width and height, a color space (RGB, CYMK etc.), and a format (uncompressed, JPEG, etc.), as well as a bitmap location pointer 492 pointing to bitmap data 495.

The strings and bitmaps are intended to be displayed on the display means 12 as additional information while a demonstration of an inherent function of the playback device 10 is being performed.

An example of a demonstration script file processed or executed on the playback device 10 is explained below by means of a demonstration script file shown in FIG. 3. The data shown in FIG. 3 represent a hex view of the “main.stm” file, and the detailed data structure is given in Table 1 below The data structure is based on to four(4)-byte integer values.

TABLE 1

```
file offset 0x0000, size 0x0024: ds_file_header
  magic_id: 0x53544152
  version: 0x00008000
  crc32: 0x00000000
  script_table_hdr: loc= 0x24, size=0x10
  string_table_hdr: loc= 0x3C, size=0x18
  bitmap_table_hdr.loc=0x64, size=0x0c
file offset 0x0024, size 0x0010: ds_script_table_header
  num_scripts = 1
  script_table: loc=0x34, size=0x08
  intial_script = 0
file offset 0x0034, size 0x0008: ds_extent (script table)
  script 0: loc=0x250, size = 0xcc
file offset 0x003C, size 0x0018: ds_string_table_header
  num_strings = 2
  encoding = 3
  data: loc=0x78, size=0x18
  string_table: loc=0x54, size=0x10
file offset 0x0054, size 0x0010: ds_extent, ds_extent (string table)
  string 0: loc=0x00, size=0x0C
  string 1: loc=0x0C, size=0x0C
file offset 0x0064, size 0x000c: ds_bitmap_table_header
  num_bitmaps = 0
  bitmap_table: loc= 0x70, size = 0x18
file offset 0x0070, size 0x0008: ds_extent
  bitmap 0: loc = 0x90, size = 0x1c0
file offset 0x0078, size 0x0018: strings
  “string 1” (4 zero bytes)
  “string 2” (4 zero bytes)
file offset 0x0090, size 0x01c0: bitmap
  ds_bitmap_header
    width = irrelevant
    height = irrelevant
    colorspace = irrelevant
    format = irrelevant
    bitmap: loc=9C, size=1b4
file offset 0x0250, size 0x00cc: script
  ds_script_header
    ticks_per_second = 0x0A
    total_ticks =0x32
    script: loc= 0x270, size=0xAC
    script_num_events = 7
    num_labels = 0
    label_table: loc=0, size=0
file offset 0x270, size 0x1c
  ds_ev_on_key_mask
    ds_event_header
      delta_time= 0
      size = 0x1c
      command = 0x00020002
      reserved = 0x00
    offset = 0x1E
    bitmask = 0x00 0x80 0x00 0x00 0x00 0x00 0x00 0x00
file offset 0x28c, size = 0x18
  ds_ev_goto
    ds_event_header
      delta_time = 0
      size = 0x18
      command = 0x00010001
      reserved = 0x00
    arg1 = 0x00
    arg2 = 0x00
file offset 0x2A4, size = 0x14
  ds_ev_clear_display
    ds_event_header
      delta_time = 0
      size = 0x14
      command = 0x00080000
      reserved = 0x00000000
  flags = 0x00000000
```

It should be noted that the elements of the structure in Table 1 may occur in a different order because the format contains byte offsets to the data.

Referring back to FIG. 2, and the operation 235, the “main.stm” file will be read out and stored in the RAM 21 with data structures and variables in accordance with the structure given in Table 1 in addition to setting the playback device 10 for the demonstration mode. In operation 235, furthermore, an integrity check of the file is performed, which means that the ID and version numbers are checked. It should be noted that a cyclic redundancy check (CRC) may be performed, whereby a check sum value calculated by a CRC algorithm such as CRC-32 may be provided at the crc32 position of the file header in Table 1.

Advantageously, the strings and the bitmap data are stored and provided in the “main.stm” file because in this case only one file has to be read and checked for integrity. It should be noted that the strings and the bitmap data may be stored and provided in separate files, which separate files in this case have to be read and checked separately, which reading and checking of more files might be more time-consuming.

After the “main.stm” file has been read out and corresponding data structures and variables have been fed with the data of the “main.stm” file, the process shown in FIG. 2 will proceed to an operation 240. Starting at the operation 240 and following a processing of the commands or events given by the script, data 445 will be performed in the form of commands by an event processor in the demonstration control data processing means 52. In the present example of the “main.stm” file shown in FIG. 3, the following commands or events shown in Table 2 are processed or executed:

TABLE 2

| | Delta | |
|---|---|---|
| Nr. | Time | Command/Event |
| 1 | 0.00 | DS_EVENT_ON_KEY_PERFORM_NEXT_EVENT |
| | | (key = DEV_UI_KEY_STOP) |
| 2 | 0.00 | Goto( script=0, time =0) |
| 3 | 0.00 | ClearDisplay |
| 4 | 0.00 | DS_EVENT_MEDIA_PREPARE_FILE (file= |
| | | test.mp3) |
| 5 | 0.00 | DS_EVENT_MEDIA_PLAY |
| 6 | 0.00 | DS_EVENT_DISPLAY_STRING_X_AT_Y_Z (String = |
| | | 0, location = 0x04 [line 3]) |
| 7 | 0.05 | DS_EVENT_DISPLAY_STRING_X_AT_Y_Z (String = |
| | | 1, location = 0x04 [line 3]) |

In operation 240, the first event of the event list will be fetched and the timer/counter 54 is supplied with the respective delta time of the event. The process will proceed to a decision operation 250 where it is checked, whether or not a user input by means of the input means 11 has occurred, i.e. pressing of a key press in this example. If said key was pressed, the process will proceed to a decision operation 255, if not, it will proceed to a decision operation 265. The decision operation 265 checks whether or not the timer/counter 54 is at zero (0). If the timer/counter 54 is at zero (0), the process will proceed to operation 270, if not, it will proceed to operation 266. In the operation 266, the timer/counter 54 is decremented by a value of one (1), and a delay will be applied which has a duration of one (1) divide by ticks per second value, which ticks per second value is a value of 0x0A in the present example.

In the decision operation 255, a check is performed whether or not the user input or the key which was pressed is assigned to an event by a key assignment event, which is the event at line no. one (1) of Tab. 2 and which assignment is the stop key 11a in the present example. Hence the process will proceed to an operation 270 where events are performed, in this case the next event after the key assignment event which is on line no. two (2). If there is no key assignment, the process will proceed to an operation 260 in which the key press is ignored or the normal function of the key will be performed. The term normal function here means the originally intended function of the key which is, for example, a playback key for starting a playback function of the playback device 10.

If no key was pressed in the check of decision operation 250, the next event after the key assignment event will be skipped and the event after the next event will be processed, which is the event on line no. three (3) in this example, wherein the timer/counter 54 will be loaded with the corresponding delta time and the process will proceed to decision operation 265. The sequence just described concerning the key assignment event has the advantage that a user interaction can be achieved in a simple manner during a demonstration.

After an event has been processed in operation 270, the process of FIG. 2. will proceed to a decision operation 275 which determines whether or not the end of the event list has been reached. If the end was reached, the process will stop at an ed box 280, if not, it will proceed to operation 240.

The event in line no. six (6) tells the event processor to display string zero (0) in location four (4), which in the present example means to display string zero (0) on line three (3) of the display means 12 by means of the display driver means 57.

In addition to the demonstration control data contained in the “main.stm” file, demonstration data in the form of a file named “test.mp3” are stored on the disc 41, which “test.mp3” file is an audio data stream file in accordance with the MPEG1 layer III (3)audio codec (MP3) in this instance. It should be noted that other audio formats may alternatively be used such, such as MP2, AAC or PCM, DPCM etc. If the command in Tab. 2, line no. five (5) is executed in the event processor, the “test.mp3” audio stream file will be processed by the demonstration data processing means. The “test.mp3” audio stream file will be decoded therein into a decoded audio data stream which will be converted into an analog audio signal in a D/A converter 56. The analog audio signal will be provided to the amplifier module 31 and be subsequently amplified to an amplified audio signal which will be offered to the loudspeaker 33 at the amplifier output 32.

From the stated short example it is easy to understand that much more complex examples may be performed. Such an example may be the demonstration of the function of the internet audio module 28 in the case where no connection of data network to the data network interface 23 is available as e.g. being possible at a store for selling said playback device 10. A prospective buyer of said playback device may be interested in the functions or features of the internet audio module. Hence a demonstration of said features may be given by simply putting the advantageous demonstration CD into the CD module 40 and starting the demonstration. In a further consequence comments and explanations about the internet audio module 28 and is function may be presented by appropriate text output respectively messages at the display means 12. Also, a limited interaction by a user by means of inputs from the input means 11 may be supported wherein e.g. music services which are virtual, which means that they will be available when connected to the data network, may be selected and related demonstration data in form of audio files may be played back. In this case, a simulation of a connecting process of the internet audio module 28 over the data network interface 23 to the music services available at the data network may be performed, including a waiting time for an access to the music services. It should be noted that other modules may be demonstrated and/or simulated in a similar manner, e.g. tuner module 25 or a PC-Link module capable to connect to personal computers PC's at a home network or related network.

It should be noted that the formats of the demonstration control data and demonstration data are not limited to file formats and audio formats. Alternative formats or storable media may be used as well, for example, a video format may be used, in which case the display means 12 will be constructed as a television or monitor for reproducing the video format. The demonstration data stored in a file are accessed through a table having the specific format or media type, and the table consists of an offset from the beginning of the file to the location of the actual data for an particular element of the media type, as shown in FIG. 4 for the media type string and bitmap.

It should further be noted that the data reading means for reading the demonstration control data as constituted by the CD module 40 may be separate from the supply means for supplying the demonstration data, which the supply means may be constructed as a second CD module which may be incorporated in the playback device 10 or which may be an external device.

It should further be noted that a hard disc or a flash memory may be used for storing the demonstration control data and/or the demonstration data instead of the CD module 40.

1. A data carrier comprising demonstration control data for controlling a demonstration of an inherent function of a playback device.

2. A data carrier as claimed in claim 1,
wherein demonstration data are provided for the demonstration of an inherent function of the playback device in addition to the demonstration control data for controlling a demonstration of an inherent function of a playback device.

3. A data carrier as claimed in claim 1 or claim 2, wherein the data carrier is an optical disc and readable in an optical way.

4. A data carrier as claimed in claim 3, wherein the data carrier is in accordance with a CD-ROM standard.

5. A data carrier as claimed in claim 1, wherein the demonstration control data are constructed as a script file.

6. A data carrier as claimed in claim 2, wherein the demonstration data are provided in a compressed format.

7. A playback device comprising:
at least one signal processing means for processing a signal;
switching means for switching the playback device into a demonstration mode in which a demonstration of an inherent function of the playback device can be performed;
supply means for supplying demonstration data for the demonstration;
data reading means for reading demonstration control data of a data carrier which comprises demonstration control data for performing the demonstration;
processing means for processing the demonstration control data such that the demonstration data are transmittable to the at least one signal processing means during processing of the demonstration control data.

8. A playback device as claimed in claim 7, wherein the reading means are constructed for reading an optically readable medium.

9. A playback device as claimed in claim 7, wherein the reading means are constructed for reading the data carrier in accordance with a CD-ROM standard.

10. A playback device as claimed in claim 7, wherein the data carrier is removable.

11. A playback device as claimed in claim 7, wherein the supply means are formed by the reading means, while said reading means in addition are designed for reading the demonstration data for the demonstration of an inherent function of the playback device.

12. A playback device as claimed in claim 7, wherein the processing means are constructed for processing demonstration control data in the form of a script file.

13. A playback device as claimed in claim 10, wherein recognition means are provided for recognizing the removable data carrier.
